(19) United States
(12) Patent Application Publication
(10) Pub. No.: US 2020/0270939 A1
(43) Pub. Date: Aug. 27, 2020

(54) APPARATUS TO MAINTAIN A CONTINUOUSLY GRADED TRANSMISSION STATE

(71) Applicant: SAGE ELECTROCHROMICS, INC., Faribault, MN (US)

(72) Inventors: Yigang WANG, Plymouth, MN (US); Carlijn L. MULDER, Minneapolis, MN (US); Troy LIEBL, Owatonna, MN (US); Cody VanDerVeen, Faribault, MN (US)

(21) Appl. No.: 16/777,046

(22) Filed: Jan. 30, 2020

Related U.S. Application Data
(60) Provisional application No. 62/809,318, filed on Feb. 22, 2019.

(51) Int. Cl. E06B 9/24; G02F 1/153

(52) U.S. Cl. CPC E06B 9/24; G02F 1/153; E06B 2009/2417; E06B 2009/2494; E06B 2009/2464

(57) ABSTRACT

The present disclosure is directed to a multi-gradient façade of a building, and more specifically, to apparatuses including electrochromic devices, such as electrochromic insulating glass units (IGUs), and methods of using the same to achieve a multi-gradient façade.

### CROSS-REFERENCE TO RELATED APPLICATION(S)

This application claims priority under 35 U.S.C. § 119(e) to U.S. Provisional Application No. 62/809,318, entitled “APPARATUS TO MAINTAIN A CONTINUOUSLY GRADED TRANSMISSION STATE,” by Yigang WANG et al., filed Feb. 22, 2019, which is assigned to the current assignee hereof and incorporated herein by reference in its entirety.

### BACKGROUND

### Field of the Disclosure

The present disclosure is directed to a multi-gradient façade of a building, and more specifically, to apparatuses including electrochromic devices, such as electrochromic insulating glass units (IGUs), and methods of using the same to achieve a multi-gradient façade.

### Related Art

Electrochromic devices, such as electrochromic glazings, can reduce the amount of sunlight and radiant energy that enters a building. Conventional electrochromic devices typically maintain a single fixed visible light transmission state (i.e., a single tint) over the entire pane of glass of the electrochromic device. For instance, the entire pane can be maintained at 0% tinting or at 100% tinting, or at some other value of tinting (e.g., 10% tinting) between the two. Other conventional electrochromic devices are formed such that a single pane of glass can have two or three fixed discrete visible light transmission states that extend across a certain portion of the pane (i.e., discrete tinting zones), but there is no gradual transition between the discrete “zones.” For instance, the top third of the single pane may be maintained at 100% tinting while the middle third may be maintained at 50% tinting (or other percentage of tinting), and the bottom third of the pane may be maintained at 0% tinting, however there is no gradual transition between the zones. Additional other conventional electrochromic devices are formed such that a single pane of glass can have two visible light transmission states that extend across a certain portion of the pane but there is only a limited gradual transition of tinting between the two “zones.” For instance, the top half of the single pane may be maintained at 100% tinting while the bottom half may be maintained at 0% tinting (or other percentage of tinting) and there is a limited gradual tint transition where the zones meet.

Further improvement in control regarding tinting of electrochromic devices and coordination of tinting across multiple electrochromic devices is desired.

### BRIEF DESCRIPTION OF THE DRAWINGS

Embodiments are illustrated by way of example and are not limited in the accompanying figures.

FIG. 1A is an illustration of a façade comprising a plurality of different shaped insulated glass units (IGUs) installed on a structure according to an embodiment.

FIG. 1B is an illustration of a façade comprising a plurality of same shaped IGUs installed on a structure according to an embodiment.

FIG. 1C is an illustration of a plurality of façades, wherein each façade comprises a plurality of IGUs installed on a structure according to an embodiment.

FIG. 2A is an illustration of a gradient façade comprising a plurality of IGUs according to an embodiment.

FIG. 2B is an illustration of a gradient façade comprising a plurality of IGUs according to an embodiment.

FIG. 2C is an illustration of a gradient façade comprising a plurality of IGUs according to an embodiment.

FIG. 2D is an illustration of a gradient façade comprising a plurality of IGUs according to an embodiment.

FIG. 2E is an illustration of a gradient façade comprising a plurality of IGUs according to an embodiment.

FIG. 2F is an illustration of a gradient façade comprising a plurality of IGUs according to an embodiment.

FIG. 3A is an illustration of a gradient façade comprising a plurality of IGUs according to an embodiment.

FIG. 3B is an illustration of a gradient façade comprising a plurality of IGUs according to an embodiment.

FIG. 3C is an illustration of a gradient façade comprising a plurality of IGUs according to an embodiment.

FIG. 3D is an illustration of a gradient façade comprising a plurality of IGUs according to an embodiment.

FIG. 3E is an illustration of a gradient façade comprising a plurality of IGUs according to an embodiment.

FIG. 3F is an illustration of a gradient façade comprising a plurality of IGUs according to an embodiment.

FIG. 4A is an illustration of a gradient façade comprising a plurality of IGUs according to an embodiment.

FIG. 4B is an illustration of a gradient façade comprising a plurality of IGUs according to an embodiment.

FIG. 5 is an illustration of a gradient façade comprising a plurality of IGUs according to an embodiment.

FIG. 6 is an illustration of a gradient façade comprising a plurality of IGUs according to an embodiment.

FIG. 7 is an illustration of a gradient façade comprising a plurality of IGUs according to an embodiment.

FIG. 8 is an illustration of a gradient façade comprising a plurality of IGUs according to an embodiment.

FIG. 9 is an illustration of a gradient façade comprising a plurality of IGUs according to an embodiment.

FIG. 10 is an illustration of a gradient façade comprising a plurality of IGUs according to an embodiment.

FIG. 11 is an illustration of a gradient façade comprising a plurality of IGUs according to an embodiment.

FIG. 12 is a process flow diagram of a method of controlling a variable tint for a façade according to an embodiment.

FIG. 13 is a process flow diagram of a method of controlling a variable tint for multiple IGUs, including multiple façades, installed on a structure according to an embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

When referring to variables, the term “steady state” is intended to mean that an operating variable is substantially constant when averaged over 10 seconds, even through the operating variable may be change during a transient state. For example, when in steady state, an operating variable may be maintained within 10%, within 5%, or within 0.9% of an average for the operating variable for a particular mode of operation for a particular device. Variations may be due to imperfections in an apparatus or supporting equipment, such as noise transmitted along voltage lines, switching transistors within a control device, operating other components within an apparatus, or other similar effects. Still further, a variable may be changed for a microsecond each second, so that a variable, such as voltage or current, may be read; or one or more of the voltage supply terminals may alternate between two different voltages (e.g., 1 V and 2 V) at a frequency of 1 Hz or greater. Thus, an apparatus may be at steady state even with such variations due to imperfections or when reading operating parameters. When changing between modes of operation, one or more of the operating variables may be in a transient state. Examples of such variables can include voltages at particular locations within an electrochromic device or current flowing through the electrochromic device.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

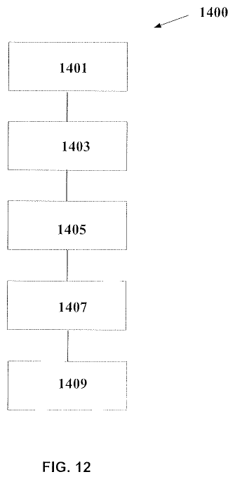

FIG. 12 shows a process flow diagram of an embodiment of a method 1400 for controlling a variable tint of a façade that contains multiple insulated glass units (IGUs) installed on a structure (such as a building), the multiple IGUs including at least a first IGU and a second IGU. Step 1401 includes mapping the multiple IGUs to a spatial coordinate system thereby establishing a position of each of the multiple IGUs relative to each other in the spatial coordinate system. The position of each of the multiple IGUs can correspond to a physical position on the structure. Step 1403 includes controlling, via a controller, a first tint profile of the first IGU based at least in part on the position of the first IGU in the spatial coordinate system. Step 1405 includes controlling, via the controller, a second tint profile of the second IGU based at least in part on the first tint profile and on the position of the second IGU in the spatial coordinate system. The method of FIG. 12 can further include controlling a third IGU as well as, if desired, a fourth IGU. Step 1407 can further comprise controlling, via the controller, a third tint profile of a third IGU based at least in part on the spatial location of the third IGU and on the first and second tint profiles. Step 1409 can further comprise controlling, via the controller, a fourth tint profile of a fourth IGU based at least in part on the spatial location of the fourth IGU and on the first, second, and third tint profiles.

As used herein, it will be understood that a “tint profile” refers to the degree of visible light transmission (VLT), and thus the corresponding tinting, as distributed across the IGU. VLT is calculated as the percentage of light that is visible through a tinted glass. A high VLT, such as 63%, indicates a high amount of visible light transmission and is considered transparent. On the other hand, the lower the VLT, the darker the tint, and ultimately the more light that is blocked. For instance, if a window has a VLT tint of five percent, that window only lets in five percent of exterior light.

An electrochromic device, such as in an IGU, can be maintained in a continuously graded transmission state for nearly any time period, for example, such as beyond the time needed for switching between states. When continuously graded, the electrochromic device can have a relatively higher electrical field between bus bars at an area with relatively less transmission and a relatively lower electrical field between the bus bars at another area with relative greater transmission. The continuous grading allows for a more visibly pleasing transition between less area of transmission to greater transmission, as compare to discrete grading. The varying locations of the bus bars can provide voltages that can range from fully bleached (highest transmission) to fully tinted (lowest transmission state), or anything in between. Still further, the electrochromic device can be operated with a substantially uniform transmission state across all of the area of the electrochromic device, with a continuously graded transmission state across all of the area of the electrochromic device, or with a combination of a portion having a substantially uniform transmission state and another portion having a continuously graded transmission state.

Many different patterns for a continuously graded transmission state can be achieved by the proper selection of bus bar location, the number of voltage supply terminals coupled to each bus bar, locations of voltage supply terminals along the bus bars, or any combination thereof. In another embodiment, gaps between bus bars can be used to achieve a continuously graded transmission state.

The first tint profile and second tint profile can beneficially transition from fully tinted to partially tinted, or to an untinted state (also called herein “fully clear” or “fully bleached”), or a combination thereof. In an embodiment, the first tint profile can transition from a fully tinted portion of the first IGU to a partially tinted portion of the first IGU. In an embodiment, the second tint profile can transition from a partially tinted portion of the second IGU to a fully clear portion of the second IGU. In an embodiment, the second tint profile can be fully tinted, partially tinted, fully clear, or a combination thereof. In an embodiment, the second tint profile can transition from a partially tinted portion of the second IGU to a fully tinted portion of the second IGU.

The method can beneficially include switching of one or a plurality of tint profiles to another tint profile. Switching can be accomplished by use of a controller or a plurality of controllers. In an embodiment, the method can include switching of the first IGU from the first tint profile to a third tint profile. In an embodiment, the third tint profile can be fully tinted, fully clear, gradient tinted, or a combination thereof. In an embodiment, the method can include switching, via a controller, the second IGU from the second tint profile to a fourth tint profile. In an embodiment, the fourth tint profile can be fully tinted, fully clear, gradient tinted, or a combination thereof.

The method can beneficially include creating a uniform gradient across a plurality of IGUs, such as a plurality of adjacent IGUs. As used herein a “uniform gradient” can refer to a first IGU having a constant tint value and a second IGU having a gradient tint. Alternately, a “uniform gradient” can also refer to both the first IGU and the second IGU having a gradient tint. In an embodiment, the first tint profile and second tint profile can form a uniform gradient tint profile across the first IGU and the second IGU. In an embodiment, the third tint profile and the fourth tint profile can form a uniform gradient tint profile across the first IGU and second IGU. In an embodiment, the first IGU can be adjacent to the second IGU in the spatial coordinate system, wherein the first tint profile and the second tint profile form a uniform gradient tint profile across the first and second IGUs. In an embodiment, a uniform gradient tint profile can vary in a horizontal direction, a vertical direction, a diagonal direction, or a combination thereof in reference to the spatial coordinate system. In an embodiment, the method can comprise forming a uniform gradient tint profile across the first, the second, a third, and a fourth IGU, wherein the uniform gradient tint varies in one of a horizontal direction, a vertical direction, and a diagonal direction in reference to the spatial coordinate system. In a specific embodiment, the method can comprise forming a gradient tint profile across a first, a second, a third, and a fourth IGU, wherein the gradient tint profile forms a shape that incorporates the first, the second, the third, and the fourth IGUs, and wherein at least one of the first, the second, the third, and the fourth tint profiles vary in one of a horizontal direction, a vertical direction, and a diagonal direction in reference to the spatial coordinate system to form the shape. The shape formed by a gradient tint profile can vary. In an embodiment, the shape can be a rectangle, a trapezoid, a triangle, or an oval.

In an embodiment, the method can include a first plurality of adjacent IGUs having a first uniform gradient tint profile and a second plurality of adjacent IGUs having a second uniform gradient tint profile. The first uniform gradient tint profile and the second uniform gradient tint profile can be the same or different.

The shape of the individual IGUs can be the same shape or different shapes. In an embodiment, the first IGU and the second IGU can have the same shape. In an embodiment, the first IGU and the second IGU can have different shapes. In an embodiment, a third IGU and a forth IGU can have the same shape or different shapes than the first and second IGUs, or have the same shape or different shapes from each other.

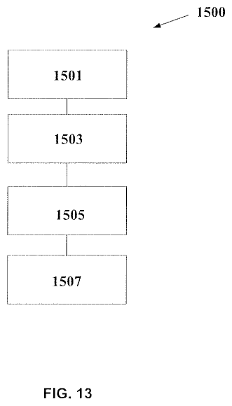

The methods described herein can apply to multiple façades of a structure or on multiple structures. FIG. 13 shows a process flow diagram of an embodiment of a method 1500 for controlling a variable tint for multiple insulated glass units (IGUs), with the multiple IGUs including multiple façades installed on one or more structures, with each façade including at least a first IGU and a second IGU. Step 1501 includes mapping the multiple IGUs to a spatial coordinate system, thereby establishing a position of each of the multiple IGUs relative to each other in the spatial coordinate system, with the position of each of the multiple IGUs corresponding to a physical position on the structure. Step 1503 includes grouping the at least first and second IGUs in a control group for the respective one of the facades. The step of grouping can further include creating multiple control groups of IGUs in one or more of the façades. Step 1505 includes controlling, via a controller, a first tint profile of the first IGU based at least in part on the position of the first IGU in the spatial coordinate system. Step 1507 includes controlling, via the controller, a second tint profile of the second IGU based at least in part on the first tint profile and on the position of the second IGU in the spatial coordinate system.

The electrochromic device, such as an IGU, can be used as part of a window, or a plurality of windows that form a facade for a building. The electrochromic device can be used within an apparatus. The apparatus can further include an energy source, an input/output unit, and a control device that controls the electrochromic device. Components within the apparatus may be located near or remotely from the electrochromic device. In an embodiment, one or more of such components may be integrated with environmental controls within a building.

The embodiments as illustrated in the figures and described below help in understanding particular applications for implementing the concepts as described herein.

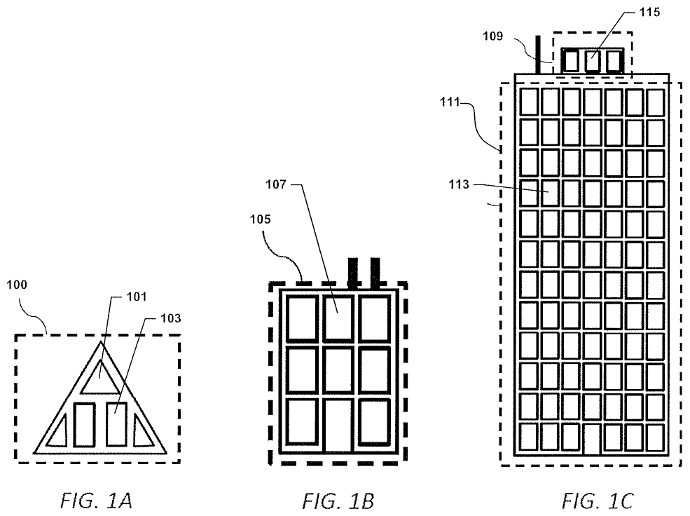

FIG. 1A is an illustration of a façade 100 comprising a plurality of insulated glass units (IGUs) installed on a structure according to an embodiment. The façade 100 comprises a combination of different shaped IGUs. A first plurality comprises triangular shaped 101 IGUs. A second plurality comprises rectangular shaped 103 IGUs. The façade is capable of comprising a gradient façade.

FIG. 1B is an illustration of a façade 105 comprising a plurality of same shaped insulated IGUs 107 installed on a structure according to an embodiment. The façade is capable of comprising a gradient façade.

FIG. 1C is an illustration of a plurality of façades (a first façade 109 and a second façade 111), wherein each façade comprises a plurality of IGUs installed on a structure according to an embodiment. The first façade 109 comprises a plurality of IGUs 113 of the same shape (rectangular) and same dimensions. The second façade 111 comprises a plurality of IGUs 115 of the same shape (rectangular) and same dimensions The first plurality of IGUs 113 have different dimensions than the second plurality of IGUs 115. The first façade and the second façade are each capable of comprising a gradient façade.

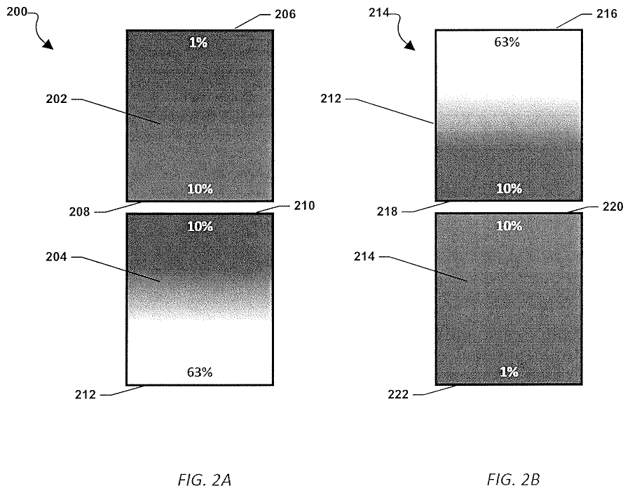

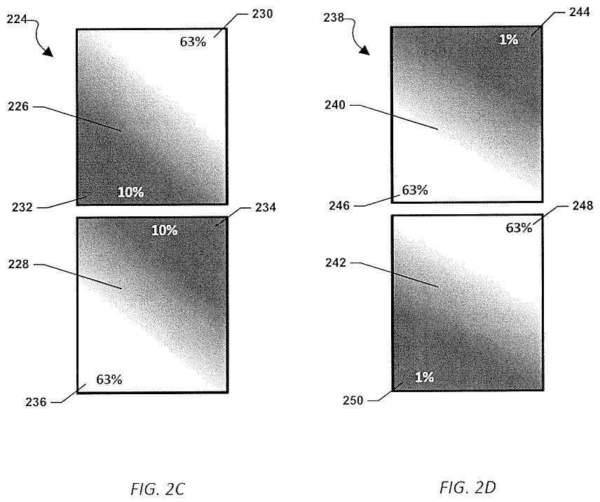

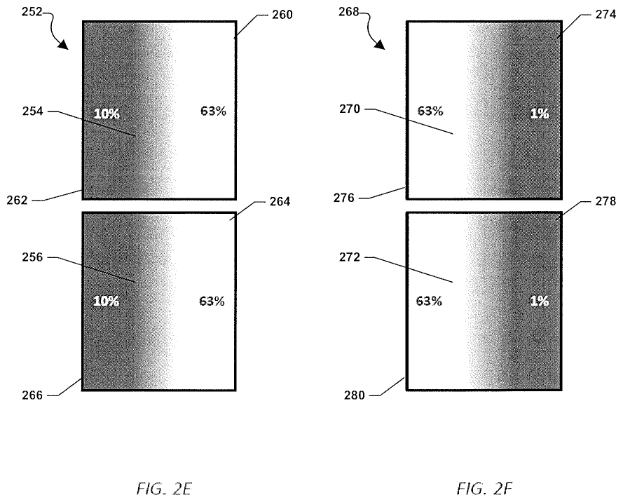

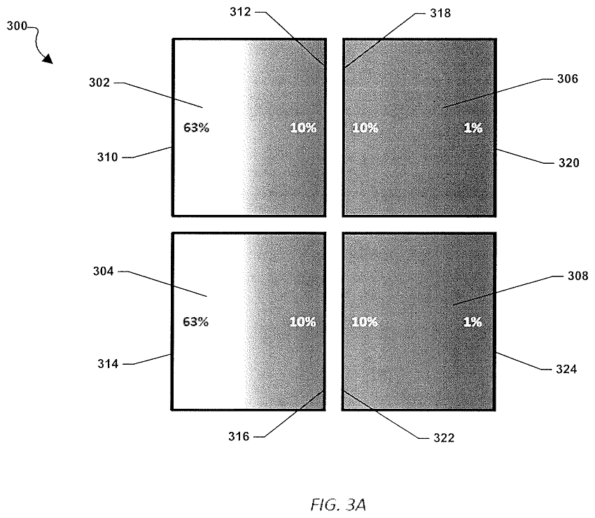

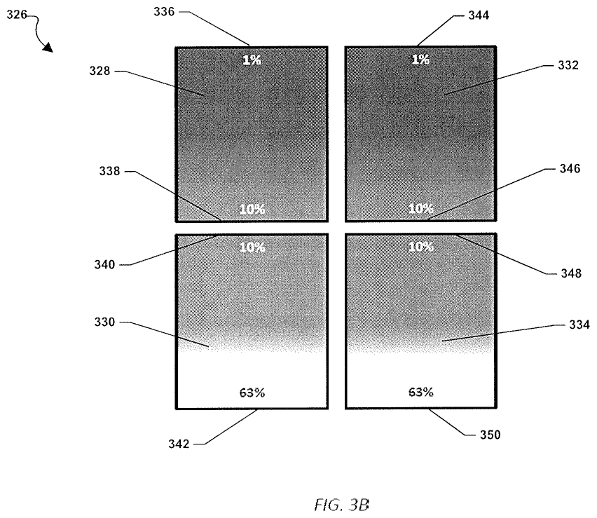

FIG. 2A is an illustration of a gradient façade 200 comprising a plurality of IGUs, specifically a first IGU 202 and a second IGU 204, according to an embodiment. The plurality of IGUs comprises a top-to-bottom tinting gradient (i.e., a visible light transmission gradient) across the facade. The first IGU comprises a continuous visible light transmission gradient that varies from about 1% transmission (highest tinting) along the upper edge 206 of the first IGU to about 10% transmission along the bottom edge 208 of the first IGU. The second IGU comprises a continuous visible light transmission gradient that varies from about 10% transmission along the upper edge 210 of the second IGU to about 63% transmission (least tinting) (also called herein “fully clear” or “fully bleached”) along the bottom edge 212 of the second IGU.

FIG. 2B is an illustration of a gradient façade 214 comprising a plurality of IGUs, specifically a first IGU 212 and a second IGU 214, according to an embodiment. The plurality of IGUs comprises a top-to-bottom tinting gradient (i.e., a visible light transmission gradient) across the facade. The first IGU comprises a continuous visible light transmission gradient that varies from about 63% transmission (least tinting—fully clear) along the upper edge 216 of the first IGU to about 10% transmission along the bottom edge 218 of the first IGU. The second IGU comprises a continuous visible light transmission gradient that varies from about 10% transmission along the upper edge 220 of the second IGU to about 1% transmission (highest tinting) along the bottom edge 222 of the second IGU.

FIG. 2C is an illustration of a gradient façade 224 comprising a plurality of IGUs, specifically a first IGU 226 and a second IGU 228, according to an embodiment. The plurality of IGUs comprises a diagonal (also called herein “corner-to-corner”) tinting gradient (i.e., a visible light transmission gradient) across the facade. The first IGU comprises a continuous visible light transmission gradient that varies from about 63% transmission (least tinting—fully clear) at the upper right corner 230 of the first IGU to about 10% transmission at the bottom left corner 232 of the first IGU. The second IGU comprises a continuous visible light transmission gradient that varies from about 10% transmission at the upper right corner 234 of the second IGU to about 63% transmission (least tinting—fully clear) at the bottom left corner 236 of the second IGU.

FIG. 2D is an illustration of a gradient façade 238 comprising a plurality of IGUs, specifically a first IGU 240 and a second IGU 242, according to an embodiment. The plurality of IGUs comprises a diagonal (also called herein “corner-to-corner”) tinting gradient (i.e., a visible light transmission gradient) across the facade. The first IGU comprises a continuous visible light transmission gradient that varies from about 1% transmission (most tinting) at the upper right corner 244 of the first IGU to about 63% transmission (least tinting—fully clear) at the bottom left corner 246 of the first IGU. The second IGU comprises a continuous visible light transmission gradient that varies from about 63% transmission at the upper right corner 248 of the second IGU to about 1% transmission at the bottom left corner 250 of the second IGU.

FIG. 2E is an illustration of a gradient façade 252 comprising a plurality of IGUs, specifically a first IGU 254 and a second IGU 256, according to an embodiment. The plurality of IGUs comprises a side-to-side (also called herein “left-to-right”) tinting gradient (i.e., a visible light transmission gradient) across the facade. The first IGU comprises a continuous visible light transmission gradient that varies from about 10% transmission along the left edge 262 of the first IGU to about 63% transmission (least tinting—fully clear) along the right edge 260 of the first IGU. The second IGU comprises a continuous visible light transmission gradient that varies from about 10% transmission along the left edge 266 of the second IGU to about 63% transmission along the right edge 264 of the second IGU.

FIG. 2F is an illustration of a gradient façade 268 comprising a plurality of IGUs, specifically a first IGU 270 and a second IGU 272, according to an embodiment. The plurality of IGUs comprises a side-to-side (also called herein “left-to-right”) tinting gradient (i.e., a visible light transmission gradient) across the facade. The first IGU comprises a continuous visible light transmission gradient that varies from about 63% transmission along the left edge 276 of the first IGU to about 1% transmission along the right edge 274 of the first IGU. The second IGU comprises a continuous visible light transmission gradient that varies from about 63% transmission along the left edge 280 of the second IGU to about 1% transmission along the right edge 278 of the second IGU.

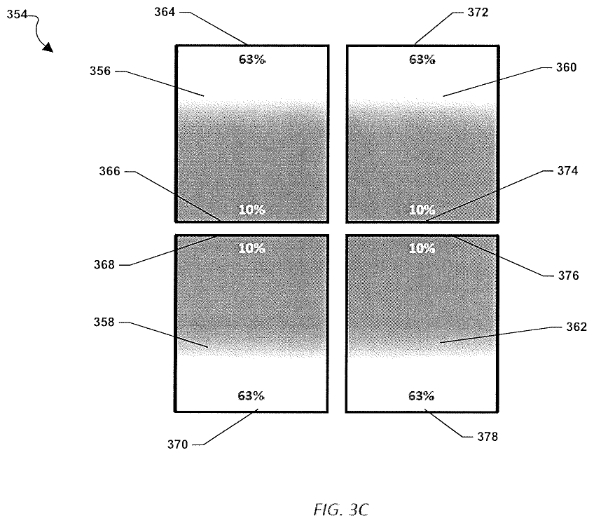

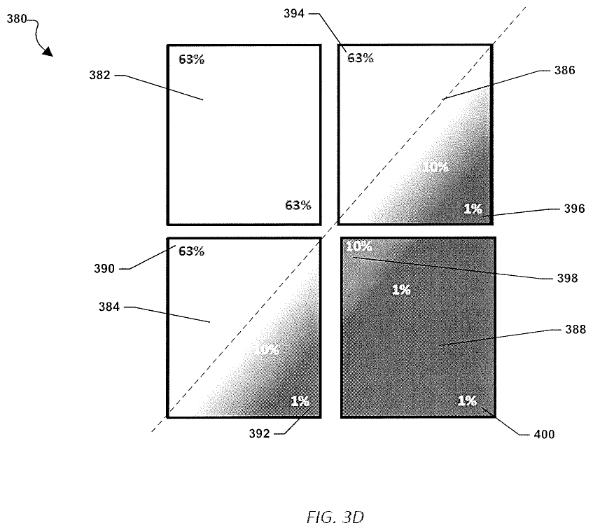

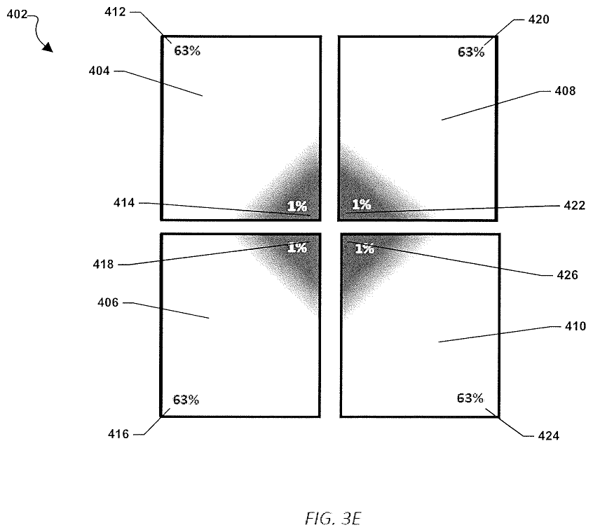

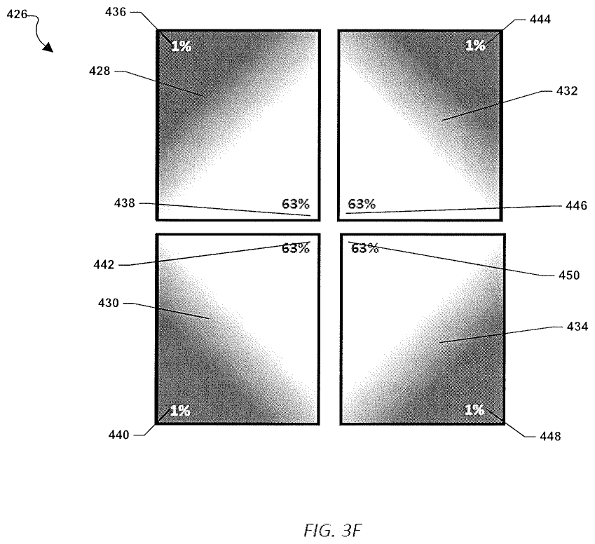

FIG. 3A is an illustration of a gradient façade 300 comprising a plurality of IGUs, specifically a first IGU 302, a second IGU 304, a third IGU 306, and a fourth IGU 308, according to an embodiment. The plurality of IGUs comprises a side-to-side (also called herein “left-to-right”) tinting gradient (i.e., a visible light transmission gradient) across the facade. The first IGU comprises a continuous visible light transmission gradient that varies from about 63% transmission along the left edge 310 of the first IGU to about 10% transmission along the right edge 312 of the first IGU. The second IGU comprises a continuous visible light transmission gradient that varies from about 63% transmission along the left edge 314 of the second IGU to about 10% transmission along the right edge 316 of the second IGU. The third IGU comprises a continuous visible light transmission gradient that varies from about 10% transmission along the left edge 318 of the first IGU to about 1% transmission along the right edge 320 of the third IGU. The fourth IGU comprises a continuous visible light transmission gradient that varies from about 10% transmission along the left edge 322 of the fourth IGU to about 1% transmission along the right edge 324 of the fourth IGU.

FIG. 3B is an illustration of a gradient façade 326 comprising a plurality of IGUs, specifically a first IGU 328, a second IGU 330, a third IGU 332, and a fourth IGU 334, according to an embodiment. The plurality of IGUs comprises a top-to-bottom tinting gradient (i.e., a visible light transmission gradient) across the facade. The first IGU comprises a continuous visible light transmission gradient that varies from about 1% transmission along the top edge 336 of the first IGU to about 10% transmission along the bottom edge 338 of the first IGU. The second IGU comprises a continuous visible light transmission gradient that varies from about 10% transmission along the top edge 340 of the second IGU to about 63% transmission along the bottom edge 342 of the second IGU. The third IGU comprises a continuous visible light transmission gradient that varies from about 1% transmission along the top edge 344 of the third IGU to about 10% transmission along the bottom edge 346 of the third IGU. The fourth IGU comprises a continuous visible light transmission gradient that varies from about 10% transmission along the top edge 348 of the fourth IGU to about 63% transmission along the bottom edge 350 of the fourth IGU.

FIG. 3C is an illustration of a gradient façade 354 comprising a plurality of IGUs, specifically a first IGU 356, a second IGU 358, a third IGU 360, and a fourth IGU 362, according to an embodiment. The plurality of IGUs comprises a top-to-bottom tinting gradient (i.e., a visible light transmission gradient) across the facade. The first IGU comprises a continuous visible light transmission gradient that varies from about 63% transmission along the top edge 364 of the first IGU to about 10% transmission along the bottom edge 366 of the first IGU. The second IGU comprises a continuous visible light transmission gradient that varies from about 10% transmission along the top edge 368 of the second IGU to about 63% transmission along the bottom edge 370 of the second IGU. The third IGU comprises a continuous visible light transmission gradient that varies from about 63% transmission along the top edge 372 of the third IGU to about 10% transmission along the bottom edge 374 of the third IGU. The fourth IGU comprises a continuous visible light transmission gradient that varies from about 10% transmission along the top edge 376 of the fourth IGU to about 63% transmission along the bottom edge 378 of the fourth IGU.

FIG. 3D is an illustration of a gradient façade 380 comprising a plurality of IGUs, specifically a first IGU 382, a second IGU 384, a third IGU 386, and a fourth IGU 388, according to an embodiment. The plurality of IGUs comprises a corner-to-corner tinting gradient (i.e., a visible light transmission gradient) across the facade. The first IGU comprises a uniform visible light transmission of 63% across the entire first IGU. The second IGU comprises a continuous visible light transmission gradient that varies from about 63% transmission at the top left corner 390 of the second IGU to about 1% transmission at the bottom right corner 392 of the second IGU. A region having a gradient intermediate transmission, such as about a 10% transmission, can be disposed in a zone, such as trapezoidal shaped zone, that begins at a line 386 bisecting the second IGU from the lower left corner to the upper right corner and extends downward toward to the 1% transmission region in the bottom right corner of the second IGU. The third IGU has the same gradient profile as the second IGU and comprises a continuous visible light transmission gradient that varies from about 63% transmission at the top left corner 394 of the third IGU to about 1% transmission at the bottom right corner 396 of the third IGU. A region having a gradient intermediate transmission, such as about a 10% transmission, can be disposed in a zone, such as trapezoidal shaped zone, that begins at a line 386 bisecting the third IGU from the lower left corner to the upper right corner and extends downward toward to the 1% transmission region in the bottom right corner of the third IGU. The fourth IGU comprises a continuous visible light transmission gradient that varies from about 10% transmission at the top left corner 398 of the fourth IGU to about 1% transmission at the bottom right corner 400 of the fourth IGU. The intermediate transmission zones of the second IGU, third IGU, and fourth IGU can have the same gradient transmission value and comprise a transmission zone cluster.

FIG. 3E is an illustration of a gradient façade 402 comprising a plurality of IGUs, specifically a first IGU 404, a second IGU 406, a third IGU 408, and a fourth IGU 410, according to an embodiment. Each of the IGUs comprises a corner-to-corner tinting gradient (i.e., a visible light transmission gradient) across the face of the IGU. The first IGU comprises a continuous visible light transmission gradient that varies from about 63% at the upper left corner 412 of the first IGU to about 1% at the bottom right corner 414 of the first IGU. The second IGU comprises a continuous visible light transmission gradient that varies from about 63% transmission at the bottom left corner 416 of the second IGU to about 1% transmission at the upper right corner 418 of the second IGU. The third IGU has comprises a continuous visible light transmission gradient that varies from about 63% transmission at the top right corner 420 of the third IGU to about 1% transmission at the bottom left corner 422 of the third IGU. The fourth IGU comprises a continuous visible light transmission gradient that varies from about 63% transmission at the bottom right corner 424 of the fourth IGU to about 1% transmission at the upper left corner 426 of the fourth IGU. Each of the adjacent corners of the first, second, third, and fourth IGUs having a 1% transmission can collectively comprise a transmission zone cluster, such as a glare control cluster.

FIG. 3F is an illustration of a gradient façade 426 comprising a plurality of IGUs, specifically a first IGU 428, a second IGU 430, a third IGU 432, and a fourth IGU 434, according to an embodiment. Each of the IGUs comprises a corner-to-corner tinting gradient (i.e., a visible light transmission gradient) across the face of the IGU. The first IGU comprises a continuous visible light transmission gradient that varies from about 1% at the upper left corner 436 of the first IGU to about 63% at the bottom right corner 438 of the first IGU. The second IGU comprises a continuous visible light transmission gradient that varies from about 1% transmission at the bottom left corner 440 of the second IGU to about 63% transmission at the upper right corner 442 of the second IGU. The third IGU comprises a continuous visible light transmission gradient that varies from about 1% transmission at the top right corner 444 of the third IGU to about 63% transmission at the bottom left corner 446 of the third IGU. The fourth IGU comprises a continuous visible light transmission gradient that varies from about 1% transmission at the bottom right corner 448 of the fourth IGU to about 63% transmission at the upper left corner 450 of the fourth IGU. Each of the adjacent corners of the first, second, third, and fourth IGUs having a 63% transmission can collectively comprise a transmission zone cluster, such as a natural light cluster.

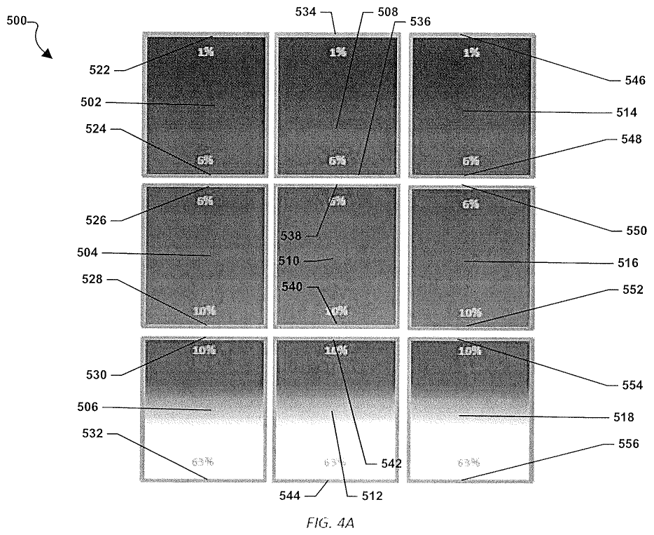

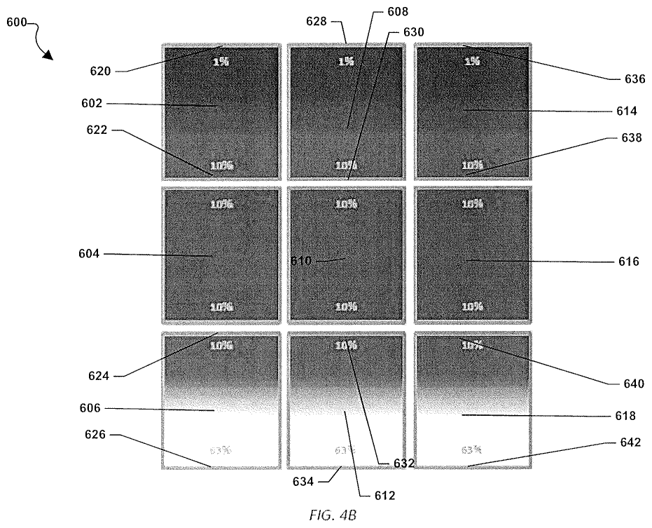

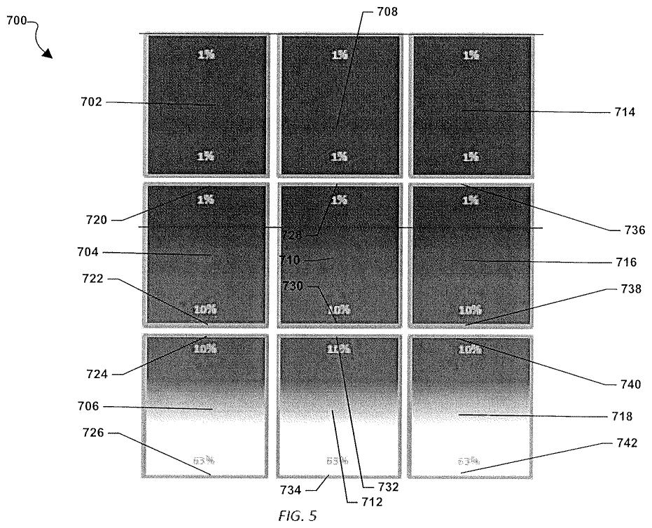

FIG. 4A is an illustration of a gradient façade 500 comprising a plurality of IGUs, specifically a first IGU 502, a second IGU 504, a third IGU 506, a fourth IGU 508, a fifth IGU 510, a sixth IGU 512, a seventh IGU 514, an eighth IGU 516, and a ninth IGU 518 according to an embodiment. The plurality of IGUs comprises a top-to-bottom tinting gradient (i.e., a visible light transmission gradient) across the facade. The first IGU comprises a continuous visible light transmission gradient that varies from about 1% transmission along the top edge 522 of the first IGU to about 6% transmission along the bottom edge 524 of the first IGU. The second IGU comprises a continuous visible light transmission gradient that varies from about 6% transmission along the top edge 526 of the second IGU to about 10% transmission along the bottom edge 528 of the second IGU. The third IGU comprises a continuous visible light transmission gradient that varies from about 10% transmission along the top edge 530 of the third IGU to about 63% transmission along the bottom edge 532 of the third IGU. The fourth IGU comprises a continuous visible light transmission gradient that varies from about 1% transmission along the top edge 534 of the fourth IGU to about 6% transmission along the bottom edge 536 of the fourth IGU. The fifth IGU comprises a continuous visible light transmission gradient that varies from about 6% transmission along the top edge 538 of the fifth IGU to about 10% transmission along the bottom edge 540 of the fifth IGU. The sixth IGU comprises a continuous visible light transmission gradient that varies from about 10% transmission along the top edge 542 of the sixth IGU to about 63% transmission along the bottom edge 544 of the sixth IGU. The seventh IGU comprises a continuous visible light transmission gradient that varies from about 1% transmission along the top edge 546 of the seventh IGU to about 6% transmission along the bottom edge 548 of the seventh IGU. The eighth IGU comprises a continuous visible light transmission gradient that varies from about 6% transmission along the top edge 550 of the eighth IGU to about 10% transmission along the bottom edge 552 of the eighth IGU. The ninth IGU comprises a continuous visible light transmission gradient that varies from about 10% transmission along the top edge 554 of the ninth IGU to about 63% transmission along the bottom edge 556 of the ninth IGU.

FIG. 4B is an illustration of a gradient façade 600 comprising a plurality of IGUs, specifically a first IGU 602, a second IGU 604, a third IGU 606, a fourth IGU 608, a fifth IGU 610, a sixth IGU 612, a seventh IGU 614, an eighth IGU 616, and a ninth IGU 618 according to an embodiment. The plurality of IGUs comprises a top-to-bottom tinting gradient (i.e., a visible light transmission gradient) across the facade. The first IGU comprises a continuous visible light transmission gradient that varies from about 1% transmission along the top edge 620 of the first IGU to about 10% transmission along the bottom edge 622 of the first IGU. The second IGU comprises a uniform visible light transmission of 10% across the entire second IGU. The third IGU comprises a continuous visible light transmission gradient that varies from about 10% transmission along the top edge 624 of the third IGU to about 63% transmission along the bottom edge 626 of the third IGU. The fourth IGU comprises a continuous visible light transmission gradient that varies from about 1% transmission along the top edge 628 of the fourth IGU to about 10% transmission along the bottom edge 630 of the fourth IGU. The fifth IGU comprises a uniform visible light transmission of 10% across the entire fifth IGU. The sixth IGU comprises a continuous visible light transmission gradient that varies from about 10% transmission along the top edge 632 of the sixth IGU to about 63% transmission along the bottom edge 634 of the sixth IGU. The seventh IGU comprises a continuous visible light transmission gradient that varies from about 1% transmission along the top edge 636 of the seventh IGU to about 10% transmission along the bottom edge 638 of the seventh IGU. The eighth IGU comprises a uniform visible light transmission of 10% across the entire eighth IGU. The ninth IGU comprises a continuous visible light transmission gradient that varies from about 10% transmission along the top edge 640 of the ninth IGU to about 63% transmission along the bottom edge 642 of the ninth IGU.

FIG. 5 is an illustration of a gradient façade 700 comprising a plurality of IGUs, specifically a first IGU 702, a second IGU 704, a third IGU 706, a fourth IGU 708, a fifth IGU 710, a sixth IGU 712, a seventh IGU 714, an eighth IGU 716, and a ninth IGU 718 according to an embodiment. The plurality of IGUs comprises a top-to-bottom tinting gradient (i.e., a visible light transmission gradient) across the facade. The first IGU comprises a uniform visible light transmission of 1% across the entire first IGU. The second IGU comprises a continuous visible light transmission gradient that varies from about 1% transmission along the top edge 720 of the second IGU to about 10% transmission along the bottom edge 722 of the second IGU. The third IGU comprises a continuous visible light transmission gradient that varies from about 10% transmission along the top edge 724 of the third IGU to about 63% transmission along the bottom edge 726 of the third IGU. The fourth IGU comprises a uniform visible light transmission of 1% across the entire fourth IGU. The fifth IGU comprises a continuous visible light transmission gradient that varies from about 1% transmission along the top edge 728 of the fifth IGU to about 10% transmission along the bottom edge 730 of the fifth IGU. The sixth IGU comprises a continuous visible light transmission gradient that varies from about 10% transmission along the top edge 732 of the sixth IGU to about 63% transmission along the bottom edge 734 of the sixth IGU. The seventh IGU comprises a uniform visible light transmission of 1% across the entire seventh IGU. The eighth IGU comprises a continuous visible light transmission gradient that varies from about 1% transmission along the top edge 736 of the eighth IGU to about 10% transmission along the bottom edge 738 of the eighth IGU. The ninth IGU comprises a continuous visible light transmission gradient that varies from about 10% transmission along the top edge 740 of the ninth IGU to about 63% transmission along the bottom edge 742 of the ninth IGU. The first, fourth, and seventh IGUs having a 1% transmission, as well as the 1% transmission portions of the second, fifth, and eighth IGUs collectively comprise a transmission zone cluster, such as a glare reduction cluster.

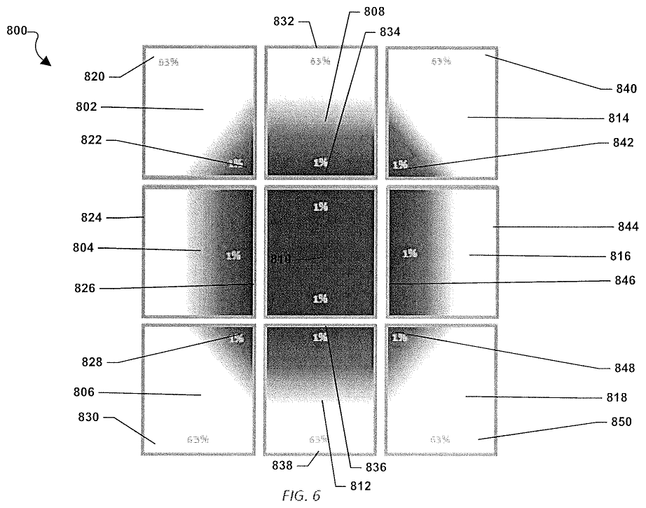

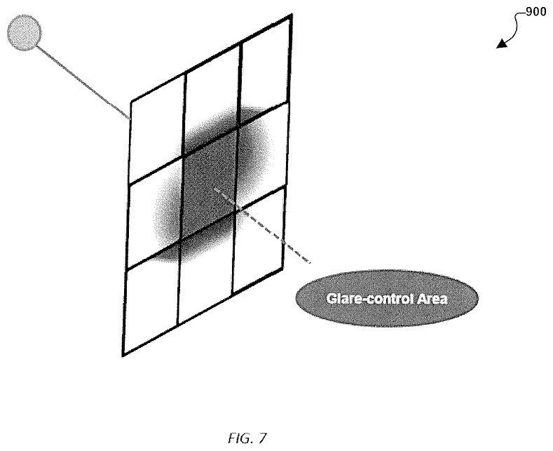

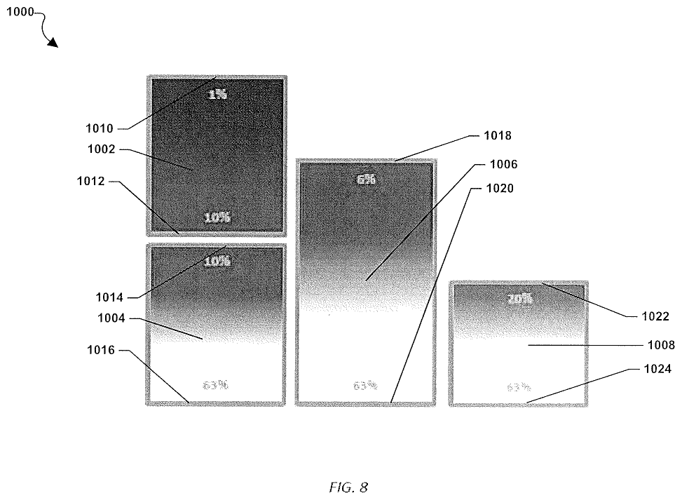

FIG. 6 is an illustration of a gradient façade 800 comprising a plurality of IGUs, specifically a first IGU 802, a second IGU 804, a third IGU 806, a fourth IGU 808, a fifth IGU 810, a sixth IGU 812, a seventh IGU 814, an eighth IGU 816, and a ninth IGU 818 according to an embodiment. The plurality of IGUs comprises a tinting gradient (i.e., a visible light transmission gradient) across the facade. The first IGU comprises a corner-to-corner tinting gradient (i.e., a visible light transmission gradient) across the face of the IGU. The first IGU comprises a continuous visible light transmission gradient that varies from about 63% at the upper left corner 820 of the first IGU to about 1% at the bottom right corner 822 of the first IGU. The second IGU comprises a side-to-side tinting gradient (i.e., a visible light transmission gradient) across the face of the IGU. The second IGU comprises a continuous visible light transmission gradient that varies from about 63% transmission along the left edge 824 of the second IGU to about 1% transmission along the right edge 826 of the second IGU. The third IGU comprises a corner-to-corner tinting gradient (i.e., a visible light transmission gradient) across the face of the IGU. The third IGU comprises a continuous visible light transmission gradient that varies from about 63% transmission at lower left corner 830 of the third IGU to about 1% transmission at the top right corner 828 of the third IGU. The fourth IGU comprises a continuous visible light transmission gradient that varies from about 63% transmission along the top edge 832 of the fourth IGU to about 1% transmission along the bottom edge 834 of the fourth IGU. The fifth IGU comprises a uniform visible light transmission of 1% across the entire fifth IGU. The sixth IGU comprises a continuous visible light transmission gradient that varies from about 1% transmission along the top edge 836 of the sixth IGU to about 63% transmission along the bottom edge 838 of the sixth IGU. The seventh IGU comprises a corner-to-corner tinting gradient (i.e., a visible light transmission gradient) across the face of the IGU. The seventh IGU comprises a continuous visible light transmission gradient that varies from about 63% transmission at an upper right corner 840 of the seventh IGU to about 1% transmission at the lower left corner 842 of the seventh IGU. The eighth IGU comprises a side-to-side tinting gradient across the face of the IGU. The eighth IGU comprises a continuous visible light transmission gradient that varies from about 63% transmission along the right edge 844 of the eighth IGU to about 1% transmission along the left edge 846 of the eighth IGU. The ninth IGU comprises a corner-to-corner tint gradient. The ninth IGU comprises a continuous visible light transmission gradient that varies from about 63% transmission at the lower right corner 850 of the ninth IGU to about 1% transmission at the top left corner 848 of the ninth IGU. The fifth IGU and the adjacent 1% transmission portions of the first, second, third, fourth, sixth, seventh, eighth, and ninth IGUs together comprise a transmission zone cluster, such as a glare control cluster (also called herein a glare control area).

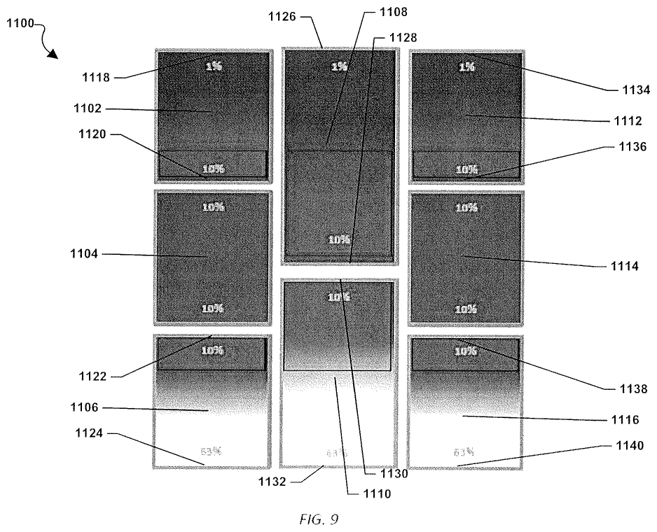

FIG. 7 is an illustration of a gradient façade 900 comprising a plurality of nine IGUs, wherein the center IGU and adjacent portions of the surrounding IGUs comprise a visible light transmission gradient that is very low, such as 1% to 5% transmission, to form a glare control area according to an embodiment.

FIG. 8 is an illustration of a gradient façade 1000 comprising a plurality of IGUs, specifically a first IGU 1002, a second IGU 1004, a third IGU 1006, and a fourth IGU 1008, according to an embodiment. The first and second IGUs are the same size and dimensions. The third and fourth IGUs are of a different in size and dimension from each other and from the first and second IGUs. The first IGU comprises a continuous visible light transmission gradient that varies from about 1% transmission along the top edge 1010 of the first IGU to about 10% transmission along the bottom edge 1012 of the first IGU. The second IGU comprises a continuous visible light transmission gradient that varies from about 10% transmission along the top edge 1014 of the second IGU to about 63% transmission along the bottom edge 1016 of the second IGU. The third IGU comprises a continuous visible light transmission gradient that varies from about 6% transmission along the top edge 1018 of the third IGU to about 63% transmission along the bottom edge 1020 of the third IGU. The fourth IGU comprises a continuous visible light transmission gradient that varies from about 20% transmission along the top edge 1022 of the fourth IGU to about 63% transmission along the bottom edge 1024 of the fourth IGU.

FIG. 9 is an illustration of a gradient façade 1100 comprising a plurality of IGUs, specifically a first IGU 1102, a second IGU 1104, a third IGU 1106, a fourth IGU 1108, a fifth IGU 1110, a sixth IGU 1112, a seventh IGU 1114, and an eighth IGU 1116 according to an embodiment. The first, second, third, sixth, seventh, and eighth IGUs are of the same size and dimensions. The third and fourth IGUs are of the same size and dimensions but are different the other IGUs. The first IGU comprises a continuous visible light transmission gradient that varies from about 1% transmission along the top edge 1118 of the first IGU to about 10% transmission along the bottom edge 1120 of the first IGU. The second IGU comprises a uniform 10% transmission across the entire IGU. The third IGU comprises a continuous visible light transmission gradient that varies from about 10% transmission along the top edge 1122 of the third IGU to about 63% transmission along the bottom edge 1124 of the third IGU. The fourth IGU comprises a continuous visible light transmission gradient that varies from about 1% transmission along the top edge 1126 of the fourth IGU to about 10% transmission along the bottom edge 1128 of the fourth IGU. The fifth IGU comprises a continuous visible light transmission gradient that varies from about 10% transmission along the top edge 1130 of the fifth IGU to about 63% transmission along the bottom edge 1132 of the fifth IGU. The sixth IGU comprises a continuous visible light transmission gradient that varies from about 1% transmission along the top edge 1134 of the sixth IGU to about 10% transmission along the bottom edge 1136 of the sixth IGU. The seventh IGU comprises a uniform 10% transmission across the entire IGU. The eighth IGU comprises a continuous visible light transmission gradient that varies from about 10% transmission along the top edge 1138 of the eighth IGU to about 63% transmission along the bottom edge 1140 of the eighth IGU.

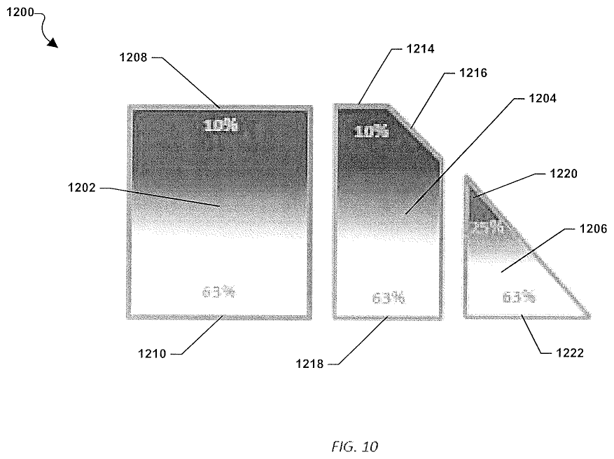

FIG. 10 is an illustration of a gradient façade 1200 comprising a plurality of IGUs, specifically a first IGU 1202, a second IGU 1204, and a third IGU 1206 according to an embodiment. The first, second, and third IGUs are of different shapes, sizes, and dimensions. The first IGU is a rectangular shape, the second IGU is a pentagonal shape, and the third IGU is a triangle shape. The first IGU comprises a continuous visible light transmission gradient that varies from about 10% transmission along the top edge 1208 of the first IGU to about 63% transmission along the bottom edge 1210 of the first IGU. The second IGU comprises a continuous visible light transmission gradient that varies from about 10% transmission along the top edge 1214 and top angled edge 1216 of the second IGU to about 63% transmission along the bottom edge 1218 of the second IGU. The third IGU comprises a continuous visible light transmission gradient that varies from about 25% transmission at the top corner 1220 of the third IGU to about 63% transmission along the bottom edge 1222 of the third IGU.

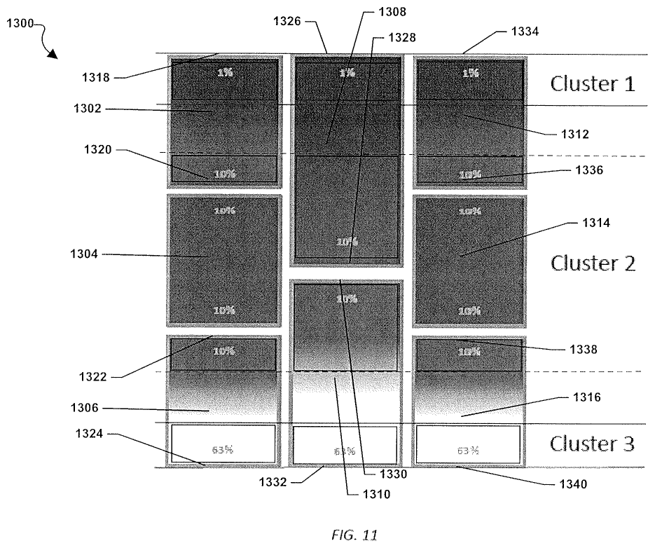

FIG. 11 is an illustration of a gradient façade 1300 comprising a plurality of IGUs, specifically a first IGU 1302, a second IGU 1304, a third IGU 1306, a fourth IGU 1308, a fifth IGU 1310, a sixth IGU 1312, a seventh IGU 1314, and an eighth IGU 1316 according to an embodiment. The first, second, third, sixth, seventh, and eighth IGUs are of the same size and dimensions. The fourth and fifth IGUs are of the same size and dimensions but are different than the other IGUs. The first IGU comprises a continuous visible light transmission gradient that varies from about 1% transmission along the top edge 1318 of the first IGU to about 10% transmission along the bottom edge 1320 of the first IGU. The second IGU comprises a uniform 10% transmission across the entire IGU. The third IGU comprises a continuous visible light transmission gradient that varies from about 10% transmission along the top edge 1322 of the third IGU to about 63% transmission along the bottom edge 1324 of the third IGU. The fourth IGU comprises a continuous visible light transmission gradient that varies from about 1% transmission along the top edge 1326 of the fourth IGU to about 10% transmission along the bottom edge 1328 of the fourth IGU. The fifth IGU comprises a continuous visible light transmission gradient that varies from about 10% transmission along the top edge 1330 of the fifth IGU to about 63% transmission along the bottom edge 1332 of the fifth IGU. The sixth IGU comprises a continuous visible light transmission gradient that varies from about 1% transmission along the top edge 1334 of the sixth IGU to about 10% transmission along the bottom edge 1336 of the sixth IGU. The seventh IGU comprises a uniform 10% transmission across the entire IGU. The eighth IGU comprises a continuous visible light transmission gradient that varies from about 10% transmission along the top edge 1338 of the eighth IGU to about 63% transmission along the bottom edge 1340 of the eighth IGU. The adjacent 1% transmission areas of the first, fourth, and sixth IGUs together comprise a first cluster of transmission areas having the same transmission value. The entire second and seventh IGUs and the adjacent 10% transmission areas of the first, third, fourth, fifth, sixth, and eighth IGUs together comprise a second cluster of transmission areas having the same transmission value. The adjacent 63% transmission areas of the third, fifth, and eighth IGUs together comprise a third cluster of transmission areas having the same transmission value.

The IGU can include an energy source, a control device (also called herein a “controller), and an input/output (I/O) unit. The energy source can provide energy to the IGU via the control device. In an embodiment, the energy source may include a photovoltaic cell, a battery, another suitable energy source, or any combination thereof. The control device can be coupled to the IGU and the energy source. The control device can include logic to control the operation of the IGU. The logic for the control device can be in the form of hardware, software, firmware, or a combination thereof. In an embodiment, the logic may be stored in a field programmable gate array (FPGA), an application-specific integrated circuit (ASIC), or another persistent memory. In an embodiment, the control device may include a processor that can execute instructions stored in memory within the control device or received from an external source. The I/O unit can be coupled to the control device. The I/O unit can provide information from sensors, such as light, motion, temperature, another suitable parameter, or any combination thereof. The I/O unit may provide information regarding the IGU 124, the energy source, or control device to another portion of the apparatus or to another destination outside the apparatus.

In an embodiment, the apparatus can be any of the IGUs described above. The IGU can be switched from a first transmission state to a graded transmission state. Switching the IGU can include biasing the first bus bar set to a first voltage and biasing the second bus bar set to a second voltage different from the first voltage. The voltages can range from 0V to 50V. The method can continue operating by maintaining the graded transmission state of the device.

Embodiments as illustrated and described above can allow a continuously graded IGU to be maintained for nearly any period of time after switching transmission states is completed. Further designs can be useful to reduce power consumption, provide more flexibility, simplify connections, or combinations thereof. An IGU can have a portion that is in a continuously graded transmission state and another portion with a substantially uniform transmission state. The precise point where transition between the continuously graded transmission state and the substantially uniform transmission state may be difficult to see. For example, the portion with the continuously graded transmission state can be fully bleached at one end and fully tinted at the other. The other portion may be fully bleached and be located beside the fully bleached end of the continuously graded portion, or the other portion may be fully tinted and be located beside the fully tinted end of the continuously graded portion. Embodiments with discrete grading between portions may be used without deviating from the concepts described herein. For example, an IGU can maintain a portion near the top of a window that is fully bleached, and a remainder that is continuously graded from fully tinted transmission state closer to the top of the window to a fully bleached transmission state near the bottom of the window. Such an embodiment may be useful to allow more light to enter to allow better color balance within the room while reducing glare. In still another embodiment, an IGU can be maintained in a continuously graded state without any portion maintained in a substantially uniform transmission state. Clearly, many different transmission patterns for an IGU are possible.

Many different aspects and embodiments are possible. Some of those aspects and embodiments are described below. Exemplary embodiments may be in accordance with any one or more of the ones as listed below.

### EMBODIMENTS

### Embodiment 1

A method for controlling a variable tint for a façade that contains multiple insulated glass units (IGUs) installed on a structure, the multiple IGUs including at least a first IGU and a second IGU, the method comprising: mapping the multiple IGUs to a spatial coordinate system thereby establishing a position of each of the multiple IGUs relative to each other in the spatial coordinate system, with the position of each of the multiple IGUs corresponding to a physical position on the structure; controlling, via a controller, a first tint profile of the first IGU based at least in part on the position of the first IGU in the spatial coordinate system; and controlling, via the controller, a second tint profile of the second IGU based at least in part on the first tint profile and on the position of the second IGU in the spatial coordinate system.

### Embodiment 2

The method of embodiment 1, wherein the first tint profile that transitions from a fully tinted portion of the first IGU to a partially tinted portion of the first IGU.

### Embodiment 3

The method of embodiment 2, wherein the second tint profile transitions from a partially tinted portion of the second IGU to a fully clear portion of the second IGU.

### Embodiment 4

The method of embodiment 2, wherein the second tint profile is one of fully tinted, partially tinted, and fully clear.

### Embodiment 5

The method of embodiment 2, wherein the second tint profile transitions from a partially tinted portion of the second IGU to a fully tinted portion of the second IGU.

### Embodiment 6

The method of embodiment 1, further comprising switching, via the controller, the first IGU from the first tint profile to a third tint profile, and wherein the third tint profile is any one of fully tinted, fully clear, and gradient tinted.

### Embodiment 7

The method of embodiment 6, further comprising switching, via the controller, the second IGU from the second tint profile to a fourth tint profile, and wherein the fourth tint profile is any one of fully tinted, fully clear, and gradient tinted.

### Embodiment 8

The method of embodiment 7, wherein the third and fourth tint profiles form a uniform gradient tint profile across the first and second IGUs.

### Embodiment 9

The method of embodiment 1, wherein the first IGU is adjacent the second IGU in the spatial coordinate system, wherein the first tint profile and the second tint profile form a uniform gradient tint profile across the first and second IGUs, and wherein the uniform gradient tint varies in one of a horizontal direction, a vertical direction, and a diagonal direction in reference to the spatial coordinate system.

### Embodiment 10

The method of embodiment 9, wherein a shape of the second IGU is different than a shape of the first IGU.

### Embodiment 11

The method of embodiment 10, wherein a bus bar layout for at least one of the first and second IGUs is tailored to ensure matching transition zones between the first and second IGUs.

### Embodiment 12

The method of embodiment 1, further comprising third and fourth IGUs, wherein the first, second, third, and fourth IGUs form an array of IGUs in the spatial coordinate system.

### Embodiment 13

The method of embodiment 12, further comprising: controlling, via the controller, a third tint profile of the third IGU based at least in part on the spatial location of the third IGU and on the first and second tint profiles; controlling, via the controller, a fourth tint profile of the fourth IGU based at least in part on the spatial location of the fourth IGU and on the first, second, and third tint profiles.

### Embodiment 14

The method of embodiment 13, further comprising forming a uniform gradient tint profile across the first, second, third, and fourth IGUs, and wherein the uniform gradient tint varies in one of a horizontal direction, a vertical direction, and a diagonal direction in reference to the spatial coordinate system.

### Embodiment 15

The method of embodiment 13, further comprising forming a gradient tint profile across the first, second, third, and fourth IGUs, wherein the gradient tint profile forms a shape that incorporates the first, second, third, and fourth IGUs, and wherein at least one of the first, second, third, and fourth tint profiles vary in one of a horizontal direction, a vertical direction, and a diagonal direction in reference to the spatial coordinate system to form the shape.

### Embodiment 16

The method of embodiment 15, wherein the shape is one of a rectangle, a trapezoid, a triangle, and an oval.

### Embodiment 17

The method of embodiment 15, further comprising receiving sensor data, at the controller, and adjusting one or more of the first, second, third, and fourth tint profiles based on the sensor data.

### Embodiment 18

The method of embodiment 17, wherein the sensor data is representative of at least one of light intensity in a volume within the structure, internal environmental conditions, external environmental conditions, electrical parameters applied to the IGUs, time of day, and day of year.

### Embodiment 19

The method of embodiment 15, further comprising receiving sensor data that is representative of a current position of the sun, and adjusting one or more of the first, second, third, and fourth tint profiles based on the sensor data as the position of the sun changes.

### Embodiment 20

A method for controlling a variable tint for multiple insulated glass units (IGUs), with the multiple IGUs including multiple façades installed on one or more structures, with each façade including at least a first IGU and a second IGU, the method comprising: mapping the multiple IGUs to a spatial coordinate system thereby establishing a position of each of the multiple IGUs relative to each other in the spatial coordinate system, with the position of each of the multiple IGUs corresponding to a physical position on the structure; grouping the at least first and second IGUs in a control group for the respective one of the facades; controlling, via a controller, a first tint profile of the first IGU based at least in part on the position of the first IGU in the spatial coordinate system; and controlling, via the controller, a second tint profile of the second IGU based at least in part on the first tint profile and on the position of the second IGU in the spatial coordinate system.

### Embodiment 21

The method of embodiment 20, wherein the grouping further includes creating multiple control groups of IGUs in one or more of the façades.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatuses and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A method for controlling a variable tint for a façade that contains multiple insulated glass units (IGUs) installed on a structure, the multiple IGUs including at least a first IGU and a second IGU, the method comprising:
mapping the multiple IGUs to a spatial coordinate system thereby establishing a position of each of the multiple IGUs relative to each other in the spatial coordinate system, with the position of each of the multiple IGUs corresponding to a physical position on the structure;
controlling, via a controller, a first tint profile of the first IGU based at least in part on the position of the first IGU in the spatial coordinate system; and
controlling, via the controller, a second tint profile of the second IGU based at least in part on the first tint profile and on the position of the second IGU in the spatial coordinate system.

2. The method of claim 1, wherein the first tint profile that transitions from a fully tinted portion of the first IGU to a partially tinted portion of the first IGU.

3. The method of claim 2, wherein the second tint profile transitions from a partially tinted portion of the second IGU to a fully clear portion of the second IGU.

4. The method of claim 2, wherein the second tint profile is one of fully tinted, partially tinted, and fully clear.

5. The method of claim 2, wherein the second tint profile transitions from a partially tinted portion of the second IGU to a fully tinted portion of the second IGU.

6. The method of claim 1, further comprising switching, via the controller, the first IGU from the first tint profile to a third tint profile, and wherein the third tint profile is any one of fully tinted, fully clear, and gradient tinted.

7. The method of claim 6, further comprising switching, via the controller, the second IGU from the second tint profile to a fourth tint profile, and wherein the fourth tint profile is any one of fully tinted, fully clear, and gradient tinted.

8. The method of claim 7, wherein the third and fourth tint profiles form a uniform gradient tint profile across the first and second IGUs.

9. The method of claim 1, wherein the first IGU is adjacent the second IGU in the spatial coordinate system, wherein the first tint profile and the second tint profile form a uniform gradient tint profile across the first and second IGUs, and wherein the uniform gradient tint varies in one of a horizontal direction, a vertical direction, and a diagonal direction in reference to the spatial coordinate system.

10. The method of claim 9, wherein a shape of the second IGU is different than a shape of the first IGU.

11. The method of claim 10, wherein a bus bar layout for at least one of the first and second IGUs is tailored to ensure matching transition zones between the first and second IGUs.

12. A method for controlling a variable tint for a façade that contains multiple insulated glass units (IGUs) installed on a structure, the multiple IGUs including at least a first IGU and a second IGU, the method comprising:
mapping the multiple IGUs to a spatial coordinate system thereby establishing a position of each of the multiple IGUs relative to each other in the spatial coordinate system, with the position of each of the multiple IGUs corresponding to a physical position on the structure;
controlling, via a controller, a first tint profile of the first IGU based at least in part on the position of the first IGU in the spatial coordinate system;
controlling, via the controller, a second tint profile of the second IGU based at least in part on the first tint profile and on the position of the second IGU in the spatial coordinate system; and
controlling, via the controller, a third tint profile of the third IGU based at least in part on the spatial location of the third IGU and on the first and second tint profiles.

13. The method of claim 12, further comprising:
controlling, via the controller, a fourth tint profile of the fourth IGU based at least in part on the spatial location of the fourth IGU and on the first, second, and third tint profiles.

14. The method of claim 13, further comprising forming a uniform gradient tint profile across the first, second, third, and fourth IGUs, and wherein the uniform gradient tint varies in one of a horizontal direction, a vertical direction, and a diagonal direction in reference to the spatial coordinate system.

15. The method of claim 13, further comprising forming a gradient tint profile across the first, second, third, and fourth IGUs, wherein the gradient tint profile forms a shape that incorporates the first, second, third, and fourth IGUs, and wherein at least one of the first, second, third, and fourth tint profiles vary in one of a horizontal direction, a vertical direction, and a diagonal direction in reference to the spatial coordinate system to form the shape.

16. The method of claim 15, wherein the shape is one of a rectangle, a trapezoid, a triangle, and an oval.

17. The method of claim 15, further comprising receiving sensor data, at the controller, and adjusting one or more of the first, second, third, and fourth tint profiles based on the sensor data.

18. The method of claim 17, wherein the sensor data is representative of at least one of light intensity in a volume within the structure, internal environmental conditions, external environmental conditions, electrical parameters applied to the IGUs, time of day, and day of year.

19. The method of claim 15, further comprising receiving sensor data that is representative of a current position of the sun, and adjusting one or more of the first, second, third, and fourth tint profiles based on the sensor data as the position of the sun changes.

20. A method for controlling a variable tint for multiple insulated glass units (IGUs), with the multiple IGUs including multiple façades installed on one or more structures, with each façade including at least a first IGU and a second IGU, the method comprising:
mapping the multiple IGUs to a spatial coordinate system thereby establishing a position of each of the multiple IGUs relative to each other in the spatial coordinate system, with the position of each of the multiple IGUs corresponding to a physical position on the structure;
grouping the at least first and second IGUs in a control group for the respective one of the facades;
controlling, via a controller, a first tint profile of the first IGU based at least in part on the position of the first IGU in the spatial coordinate system; and
controlling, via the controller, a second tint profile of the second IGU based at least in part on the first tint profile and on the position of the second IGU in the spatial coordinate system.
